(19) United States
(12) Patent Application Publication
(10) Pub. No.: US 2015/0014945 A1
(43) Pub. Date: Jan. 15, 2015

(54) Back-Up Ring Design "Split & Close"

(71) Applicant: GM Global Technology Operations LLC, Detroit, MI (US)

(72) Inventors: Axel Heise, Mainz (DE); Patrick Breuer, Montabaur (DE); Jens-Uwe Sparschuh, Nackenheim (DE)

(21) Appl. No.: 13/940,552

(22) Filed: Jul. 12, 2013

(51) Int. Cl. F16J 15/06

(52) U.S. Cl. CPC F16J 15/067
USPC 277/637

(57) ABSTRACT

A back-up ring assembly for high pressure gas components includes a first ring having and a second ring. The first ring is split at a first location with a first split angle, while the second ring is split at a second location with a second split angle. The first ring is concentrically positioned adjacent the second ring with the first location being offset relative to the second location. The back-up ring assembly is positionable adjacent to an O-ring in a sealed coupling in a high pressure application.

### TECHNICAL FIELD

In at least one aspect, the present invention is related to sealing components for higher pressure applications.

### BACKGROUND

High pressure gas components such as valves, regulators, and vessels are used in critical sealing applications. Such components are used in assemblies that have interfaces where O-rings are supported by a back-up ring. Back-up rings are used in conjunction with O-rings for both static and dynamic sealing applications. They prevent extrusion of the O-ring when it is subjected to high pressures, or when the extrusion gaps are excessive. In many applications, a back-up ring is used on both sides of the O-ring.

Common back-up rings are made of hard supporting materials, which need to be cut/split for assembling. Unfortunately, the split slots of such O-rings tend to slit the O-ring material during the lifetime of the assemblies.

Alternative back-up rings are made of solid, but softer, material which allows spreading for assembling. Although these alternative back-up rings work reasonably well, they tend to get destroyed by the too high pressure extrusion forces over time. Experiences in the past show both of them fail during lifetime.

Accordingly, there is a need for improved back-up rings for higher pressure application.

### SUMMARY

The present invention solves at least one problem of the prior art by providing in at least one embodiment a back-up ring assembly for high pressure gas components. The back-up ring assembly includes a first ring and a second ring. The first ring is split at a first location with a first split angle, while the second ring is split at a second location with a second split angle. The first ring is concentrically positioned adjacent the second ring with the first location being offset relative to the second location. The back-up ring assembly is positionable adjacent to an O-ring in a sealed coupling in a high pressure application. Advantageously, the back-up ring design overcomes prior art durability issues such as ring extrusion and O-ring slitting destruction.

In another embodiment, a sealing assembly for high pressure gas components is provided. The sealing assembly includes a first sealing section and a back-up ring assembly. The back-up ring assembly includes a first ring having a quadrilateral cross section, and a second ring having a quadrilateral cross section. The first ring has a first resealed split at a first location with a first split angle while the second ring has a second resealed split at a second location with a second split angle. The second ring is concentrically placed about the first sealing section and positioned over the first ring with the first location being offset relative to the second location such that the back-up ring assembly is adjacent to an O-ring in a gas sealing couple.

In still another embodiment, a sealing assembly for high pressure gas components is provided. The sealing assembly includes a first sealing section and a back-ring assembly. The back-up ring assembly includes a first ring defining a first split at a first location, a second ring defining a second split at a second location, and a third ring defining a third split at a third location. The first ring, the second ring, and the third ring are concentrically placed about the first sealing section. The first ring is adjacent to the second ring with the first location being offset relative to the second location. The second ring is adjacent to the third ring with the third location being offset relative to the second location. The back-up ring assembly is adjacent to an O-ring in a gas sealing couple.

### BRIEF DESCRIPTION OF THE DRAWINGS

Exemplary embodiments of the present invention will become more fully understood from the detailed description and the accompanying drawings, wherein:

FIG. 1A is a side view of a sealing assembly having a back-up seal and an O-ring;

FIG. 1B is a side view of the sealing assembly of FIG. 1A aligning to a mating sealing assembly shown in cross section;

FIG. 1C is a side view of the back-up ring used in FIGS. 1A and 1B;

FIG. 2A is a perspective view of a ring used in the back-up ring depicted in FIGS. 1A-C;

FIG. 2B is a side view showing the alignment of two rings in a back-up seal;

FIG. 2C is a cross section of a ring used in the back-up ring depicted in FIGS. 1A-C;

FIG. 3 is a schematic flowchart showing the assembling of the back-seal over a first sealing assembly;

FIG. 4 is a schematic showing the welding of the back-up seal components together; and

FIG. 5 is a schematic illustration of an ultra-sonic welding system for welding the back-up seal components together.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application where publications are referenced, the disclosures of these publications in their entireties are hereby incorporated by reference into this application to more fully describe the state of the art to which this invention pertains.

The term “gas sealing couple” as used herein in one embodiment means a mating between two sealing surfaces in a gas or fluid application typically with an O-ring interposed between the two sealing surfaces.

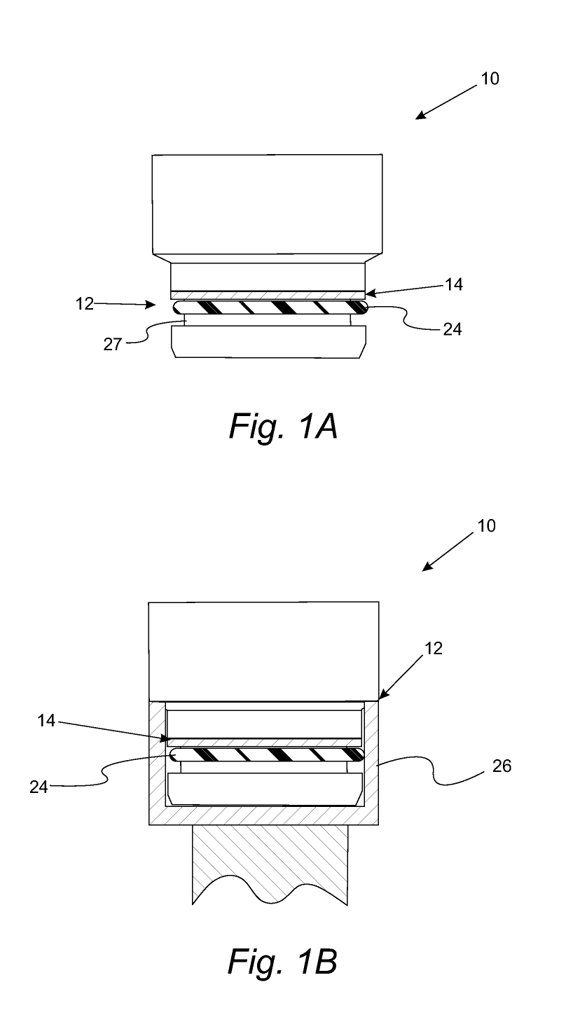

With reference to FIGS. 1A and 1B, schematic illustrations of a sealing assembly for high pressure gas component sealing applications are provided. Sealing assembly 10 includes first sealing section 12 which is part of a gas sealing couple. Back-up ring 14 includes first ring 16 and second ring 18. First ring 16 has first split 20 at a first location while second ring 18 has second split 22 at a second location. First ring 16 and second ring 18 are concentrically positioned about first sealing section 12. Moreover, first ring 16 is positioned adjacent to second ring 18 with the first location being offset (i.e., does not line up with) relative to the second location. Back-up ring 14 is positioned adjacent to O-ring 24 in a gas sealing couple formed by first section 12 and second sealing section 26 which mates to the first sealing section. FIGS. 1A and 1B depict an example in which back-up ring 14 and O-ring 24 are positioned in groove 27. Although FIG. 1A depicts a piston including the back-up ring, it should be appreciated that virtually any high pressure assembly having a gas sealing coupling can utilize back-up ring 14.

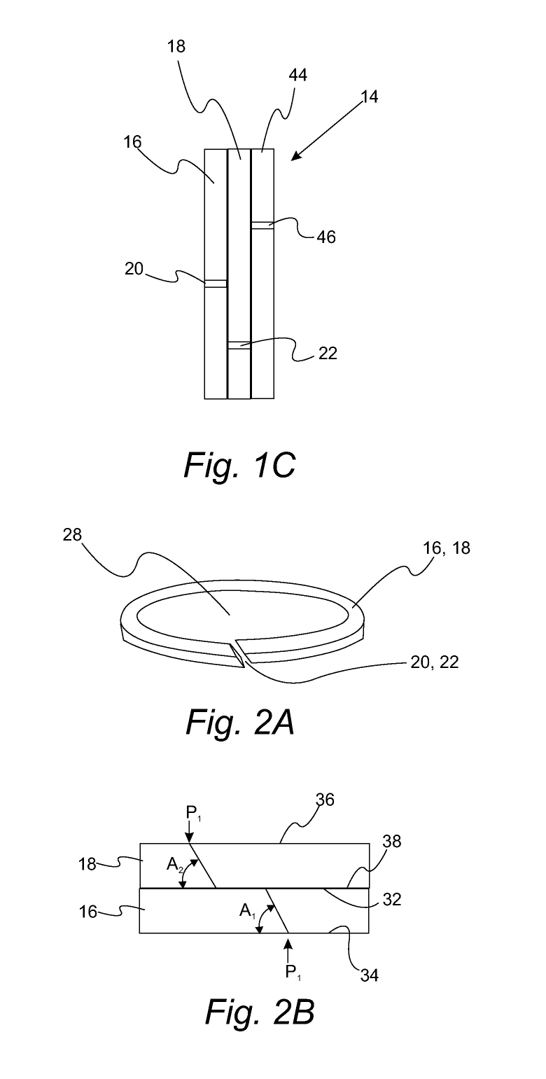

With reference to FIGS. 2A, 2B, and 2C, first ring 16 and second ring 18 are generally circular defining a central opening 28 through which first sealing section 12 is positioned. In a refinement, first ring 14 and second ring 16 having a quadrilateral cross section 30 which is typically rectangular or square. First ring 16 has top surface 32 and bottom surface 34 while second ring 18 has top surface 36 and bottom surface 38. In a variation, first split 20 is at a first split angle A₁ with respect to top surface 32 and bottom surface 34, and second split 22 is at a second split angle A₂ with respect to top surface 36 and bottom surface 38. In a further refinement, first split angle A₁ and second split angle A₂ are each independently from about 30 to 90 degrees. In still another refinement, first split angle A₁ and second split angle A₂ are each independently 90 degrees. It should be appreciated that first ring 16 and second ring 18 can be made from virtually any material that is used in the prior art for back-up rings. Examples of suitable materials for forming first ring 16 and second ring 18 include metals and polymeric resins. Useful polymers include, but are not limited to, polyphenylene sulfide (PPS); nitrile rubber (e.g., NBR); copolymers of hexafluoropropylene and vinylidene fluoride (VITON®); terpolymers of tetrafluoroethylene, vinylidene fluoride and hexafluoropropylene (VITON®); terpolymers of tetrafluoroethylene, vinylidene fluoride and perfluoromethylvinylether(VITON®); polyamides (NYLON®); polytetrafluoroethylene (e.g., TEFLON®); and combinations thereof.

In a variation of the present embodiment, back-up ring includes one or more additional rings of the same general construction as first ring 16 and second ring 18. In such variations, the additional rings define a split that is offset relative to the other rings when forming a seal. FIGS. 1A-C depict an example in having three rings in which third ring 44 with split 46 is positioned adjacent to second ring 18 such that split 46 is offset (i.e., does not line up with) from split 22. As set forth above, third ring 44 defines split 46 having a split angle typically from 30 to 90 degrees. In a further refinement, the third split angle is 90 degrees. It should also be appreciated that in this example first ring 18 and third ring 44 are adhered to (i.e., welded to) opposite sides of second ring 18. In still another refinement, the back-up seal includes yet one or more additional rings (e.g., 4 to 8 rings in all).

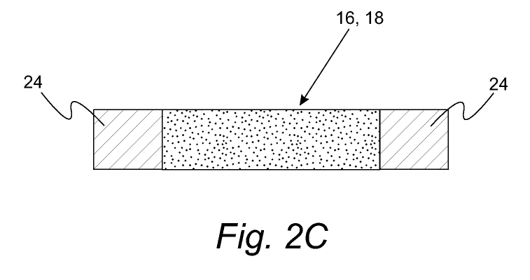

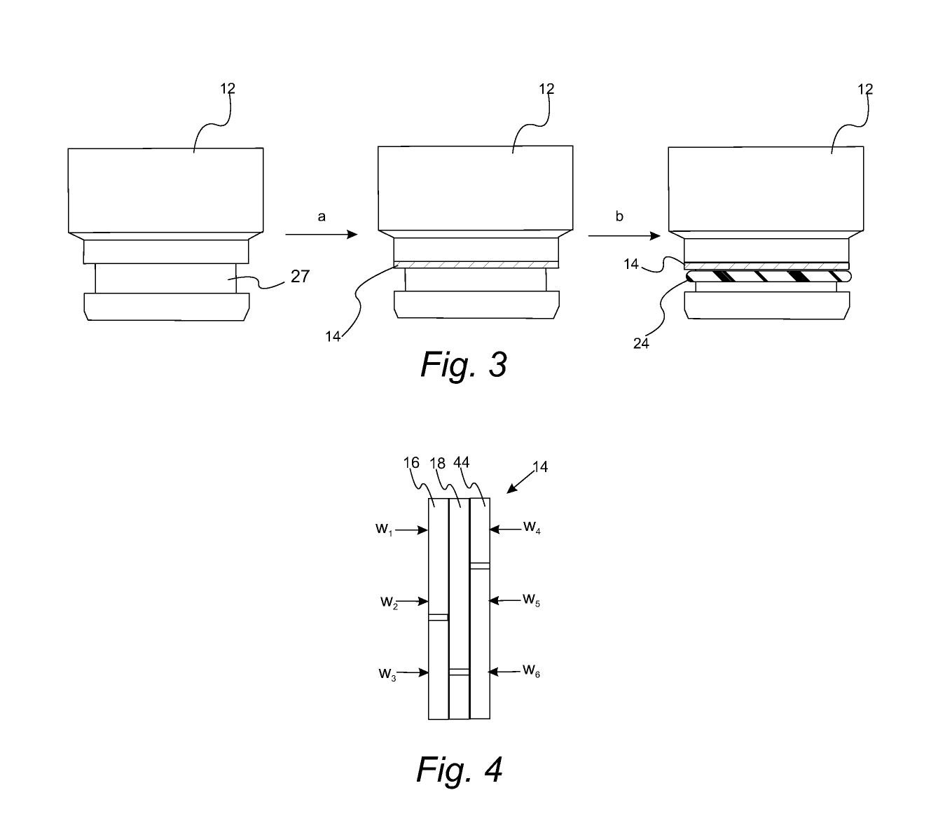

With reference to FIGS. 3 and 4, a schematic flowchart showing the assembly of back-up ring over first sealing section 12 is provided. In step a), each ring of back-up ring 14 is positioned over first sealing section 12 (typically independently). In the example of FIGS. 3 and 4, first ring 16, second ring 18, and third ring 44 are utilized. It should be appreciated that additional rings of the same design may be used as set forth above. As depicted in FIG. 4, the first ring 16, second ring 18, and third ring 44 are welded together after all are positioned as indicated by arrows w₁₋₆. The present invention is not limited by the type of welding used to adhere the rings together. For example, ultra-sonic welding and laser welding may be used for this purpose. In particular, spot welding may be utilized. In one variation, the rings are welded after a subset of the rings are positioned. In step b), O-ring 24 is positioned adjacent to assembled back-up ring 14.

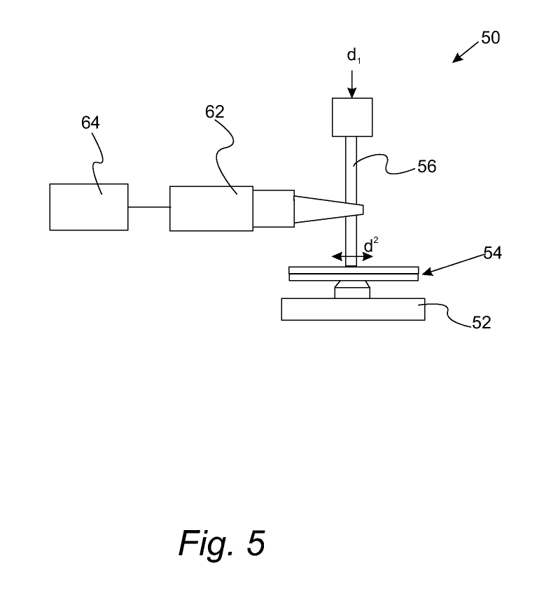

With reference to FIG. 5, a schematic illustration of an ultra-sonic welding apparatus that may be used to weld together the rings of back-up ring 14 is provided. Ultra-sonic welding apparatus 50 includes anvil 52 which holds work piece 54 to be welded. Sonotrode 56 contacts work piece 54 with a force applied along direction d₁. Transducer 60 vibrates sonotrode 56 along direction d₂ thereby welding the work piece together. Power supply 62 is used to power transducer 60.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A sealing assembly for high pressure gas components, the sealing assembly comprising:
a first sealing section; and
a back-ring assembly including a first ring defining a first split at a first location and a second ring defining a second resealed split at a second location, the first ring and the second ring concentrically placed about the first sealing section, the first ring placed adjacent to the second ring with the first location being offset relative to the second location such that the back-up ring assembly is adjacent to an O-ring in a gas sealing couple.

2. The sealing assembly of claim 1 wherein the first ring and the second ring are adhered together.

3. The sealing assembly of claim 2 wherein the first ring and the second ring are adhered by welding.

4. The sealing assembly of claim 1 wherein the first ring and the second ring each independently have a quadrilateral cross section.

5. The sealing assembly of claim 1 wherein the first ring and the second ring each independently have a rectangular or square cross section.

6. The sealing assembly of claim 1 wherein the first ring defines a first split angle and the second ring defines a second split angle.

7. The sealing assembly of claim 6 wherein the first split angle and the second split angle are each independently from 30 to 90 degrees.

8. The sealing assembly of claim 1 wherein the first ring and the second ring each independently comprise a metal or a polymer.

9. The sealing assembly of claim 1 wherein the first ring and the second ring each independently comprise polyphenylene sulfide; nitrile rubber; copolymers of hexafluoropropylene and vinylidene fluoride; terpolymers of tetrafluoroethylene, vinylidene fluoride and hexafluoropropylene; terpolymers of tetrafluoroethylene, vinylidene fluoride and perfluoromethylvinylether; polyamides; polytetrafluoroethylene; and combinations thereof.

10. The sealing assembly of claim 1 further comprising at least one additional ring.

11. The sealing assembly of claim 1 further comprising a second sealing section mating to the first sealing section to form the gas sealing couple.

12. A sealing assembly for high pressure gas components, the sealing assembly comprising:
a first sealing section; and
a back-up ring assembly including a first ring defining a first split at a first location, a second ring defining a second split at a second location, and a third ring defining a third split at a third location; the first ring, the second ring, and the third ring concentrically positioned about the first sealing section, the first ring being adjacent to the second ring with the first location being offset relative to the second location, the second ring being adjacent to the third ring, the back-up ring assembly is adjacent to an O-ring in a gas sealing couple.

13. The sealing assembly of claim 12 wherein the first ring and the third ring are adhered to opposite sides of the third ring.

14. The sealing assembly of claim 13 wherein the first ring, the second ring, and the third ring are adhered by welding.

15. The sealing assembly of claim 12 wherein the first ring and the second ring each independently have a quadrilateral cross section.

16. The sealing assembly of claim 12 wherein the first ring defines a first split angle, the second ring defines a second split angle, and the third ring defines a third split angle, the first split angle, the second split angle, and the third split angle being from 30 to 90 degrees.

17. The sealing assembly of claim 12 wherein the first ring and the second ring each independently comprise a metal or a polymer.

18. The sealing assembly of claim 12 wherein the first ring and the second ring each independently comprise polyphenylene sulfide; nitrile rubber; copolymers of hexafluoropropylene and vinylidene fluoride; terpolymers of tetrafluoroethylene, vinylidene fluoride and hexafluoropropylene; terpolymers of tetrafluoroethylene, vinylidene fluoride and perfluoromethylvinylether; polyamides; polytetrafluoroethylene; and combinations thereof.

19. The sealing assembly of claim 12 further comprising at least one additional ring.

20. The sealing assembly of claim 12 further comprising a second sealing section mating to the first sealing section to form the gas sealing couple.
